(19) United States
(12) Patent Application Publication
(10) Pub. No.: US 2017/0367546 A1
(43) Pub. Date: Dec. 28, 2017

(54) Method and Apparatus for Folding and Opening-Up Wipes

(71) Applicant: BETTER ALL ROUND LIMITED, London, Greater London (GB)

(72) Inventors: Oday Abbosh, London, Greater London (GB); Philip Russell Fawcus, Cambridgeshire (GB); Julian Brandon-Jones, Cambridgeshire (GB); Emanuel Nannizzi, Lucca (IT); Gianluca Giometti, Lucca (IT); Dave Reed, Suffolk (GB)

(21) Appl. No.: 15/536,154

(22) PCT Filed: Dec. 17, 2015
(86) PCT No.: PCT/GB2015/054057

§ 371 Date: Jun. 15, 2017

(30) Foreign Application Priority Data
Dec. 18, 2014 (GB) 1422632.8

(51) Int. Cl. A47K 10/16; B31F 1/00; B31D 1/04; B31D 5/00

(52) U.S. Cl. CPC A47K 10/16; B31D 5/0086; B31F 1/0009; B31D 1/04; B65H 2404/2614; B65H 2301/44734; B65H 2301/323; B65H 2406/323; B65H 2701/11238; B65H 2701/1924; B65H 2301/4474

(57) ABSTRACT

Apparatus is provided for manufacturing a wipe in a three dimensional form out of an essentially flat piece of material. The apparatus produces a blank (12) of essentially flat planar form with a pleat folded on each side. The folded blanks are fed by a conveyor belt (21) to an opening station (22). The opening station comprises a pair of movable pinch rollers (34, 35) which selectively grab individual blanks from the conveyor belt and feed them via belts (32, 33) to a pair of counter-rotating drums (30, 31). The blanks are ejected from the drums, which partially opens them up in the process. The partially open blanks are fed onto a shaped former (37), where the final process of forming the wipe into its chosen three dimensional form is completed.

This invention relates to wipes.

The term “wipes” is used herein to refer to the kinds of disposable absorbent products known variously as tissues, cloths, paper towels, kitchen roll and the like, which may be made of paper, cloth or any other suitable material or combination of materials and which may be moist, wet or dry and which may be embossed, perforated, quilted or printed or have any other surface decoration or treatment and which may be otherwise treated, e.g. by impregnation with perfume, lotions and/or disinfectant.

The invention provides a method of producing wipes in a three dimensional form from an essentially flat piece of material, including putting at least two creases in the piece of material, folding the piece of material about these creases to create a blank of essentially planar form, and opening out said blank into a three dimensional form.

The invention also provides apparatus for manufacturing a wipe in a three dimensional form out of an essentially flat piece of material, said apparatus including means for putting at least two creases in the piece of material, means for folding the piece of material about these creases to create a blank of essentially planar form, and opening out the blank into a three dimensional form.

By way of example, embodiments of the invention will now be described with reference to the accompanying drawings, in which:

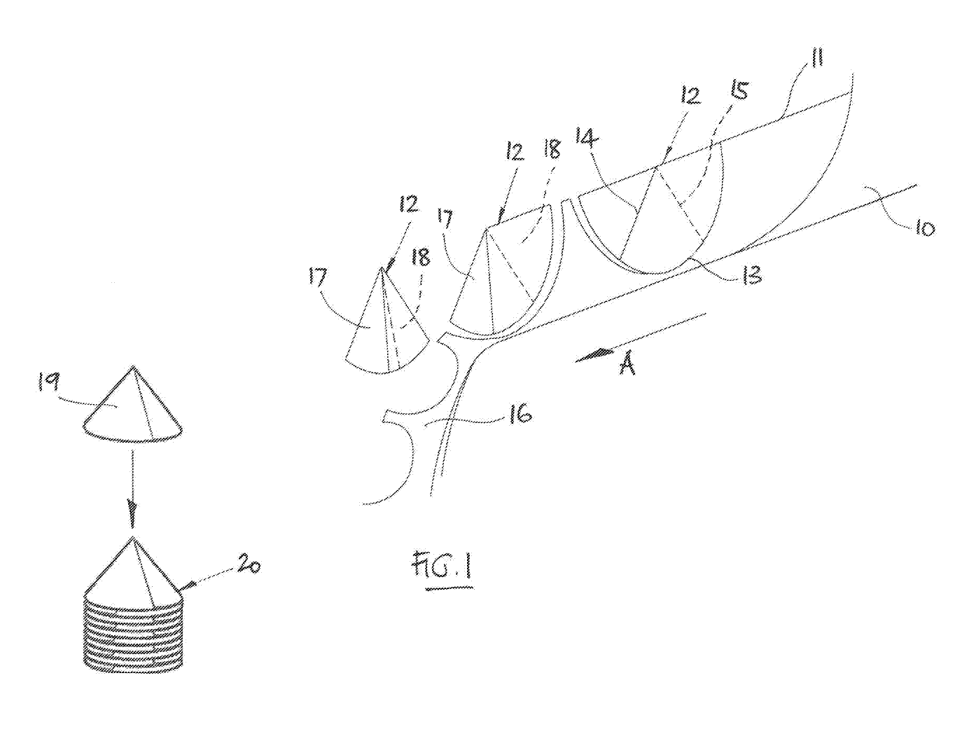

FIG. 1 is a schematic illustration of a method of producing wipes in accordance with the invention,

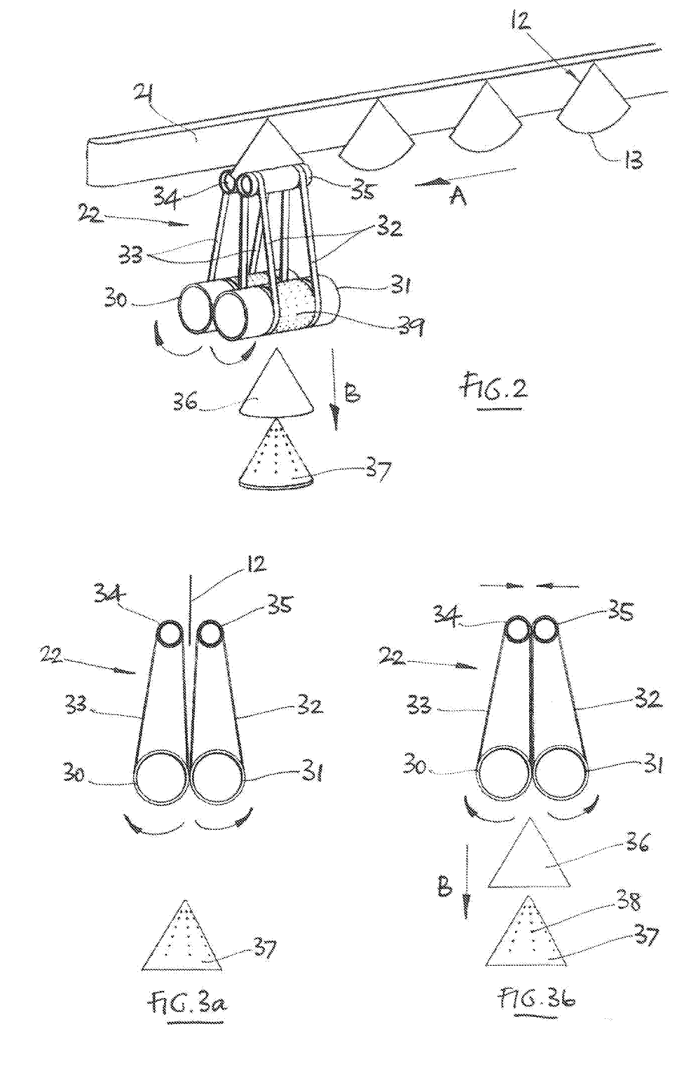

FIG. 2 shows a station for forming blanks into three dimensional wipes, and

FIGS. 3a and 3b illustrate operation of the wipe forming station of FIG. 2.

It is proposed to produce wipes having a three dimensional shape, starting from a piece of substantially flat material. The formed wipes are to be collated and packaged together in their three dimensional shape in the form of a nested stack. A suitably shaped dispenser is used to contain the stack with the upper most wipe ready to be taken for use.

15

The preferred three dimensional shape for the wipes is conical, with the dispenser holding the stack in use with the apex of the wipes extending upwardly.

In a preferred method according to the invention, as seen in FIG. 1, the wipe production process starts with a continuous elongate web of material 10. The web 10 is fed, eg from a roll, onto a production line in the direction of arrow A. In a first operation, a first folding station acts to fold the web 10 in half along its longitudinal centreline. This produces a doubled-over web 10 with a folded edge 11.

The next operation involves a cutting and creasing station to cut a blank 12 out of the folded web 10 and put creases 14, 15 into it. This can conveniently be achieved in a single operation, eg by means of counter-rotating drums and a fly cutter. The cutting and creasing station cuts the blank 12 in a semi-circular shape, with its straight side being the folded edge 11 of the web 10 and its curved side forming free edges 13. The unwanted remainder 16 of the web 10 is conveniently fed away for re-cycling.

The creases 14, 15 are arranged to be formed in the blank 12 from opposite sides (in FIG. 1, crease 14 is formed from the visible side of the blank 12, whereas crease 15 is formed from the opposite, unseen side). The purpose of the creases 14, 15 is to facilitate folding of the blank 12, and they are formed from opposite sides because the blank will be folded from opposite sides, as will be described later.

As seen in FIG. 1, the creases 14, 15 both extend radially from the mid-point of the folded edge 11 to the free edges 13 of the blank 12. The creases 14, 15 are arranged symmetrically on the blank 12 and in this case, they each subtend an angle of approximately 45° with respect to the folded edge 11. This produces a desired three dimensional form for the finished wipe having a cone angle of around 60°. It will of course be understood that the arrangement of the creases may be varied in order to produce a different cone angle.

The next operation involves a second folding station in which the blank 12 is folded about its creases 14, 15 to create two pleats 17, 18. As noted above, the folding operation forms one of the pleats 17, 18 on one side of the blank 12 and the other pleat on the other side. The second folding station can conveniently use counter-rotating drums, with an air blade picking up the blank 12 by a leading edge (with respect to the direction of arrow A) in order to fold it about crease 14 to form the pleat 17. A counter-rotating bail arm can be used to pick up the blank 12 by a trailing edge (with respect to the direction of arrow A) in order to fold it about crease 15 to form pleat 18.

The blank 12 leaves the second folding station in substantially flat planar form, but now twice folded with pleats 17, 18 on either side. The blanks 12 then undergo further operations where they are opened out into the three-dimensional form of the finished wipe 19, which in this case is conical, with the wipes then being collated to form a stack 20.

FIG. 2 shows an opening station 22 for transforming the blanks 12 from their substantially flat planar folded form into the three-dimensional form of the finished wipe. The blanks 12 are conveniently conveyed to the opening station 22 by a conveyor belt 21 with vacuum suction pressure. As will be seen in FIG. 2, the blanks 12 are arranged to be held by the conveyor belt 21 with their free edges 13 hanging clear below it. This enables the blanks 12 to be picked up by the mechanism of the opening station 22.

The mechanism of the opening station 22 comprises a pair of counter-rotating drums 30, 31 arranged with their rotational axes parallel. Each of the drums 30, 31 is connected via a pair of belts 32, 33 to a respective pinch roller 34, 35. The pinch rollers 34, 35 are also arranged with their rotational axes parallel. The belts 32, 33 are conveniently trained about the drums 30, 31 and rollers 34, 35 in grooves so as to lie essentially flush with the cylindrical outer surfaces. The cylindrical surfaces of the drums 30, 31 and/or rollers 34, 35 and/or belts 32, 33 are preferably textured and/or of suitably chosen materials in order to be able to provide sufficient grip for manouevring the blank 12.

As a further aid to manouevring the blank, the drums 30, 31 are conveniently perforated with a series of holes 39. This allows the possibility of introducing air pressure at the cylindrical surface of each drum 30, 31. In this case, vacuum suction pressure is used, and this is preferably able to be applied selectively at particular stages in the rotational movement of the drums 30, 31.

The pinch rollers 34, 35 are mounted so as to be movable towards and away from each other. The purpose of this is to enable individual blanks 12 to be picked from the conveyor belt selectively. The operation of the pinch rollers 34, 35 is seen in FIGS. 3a and 3b.

FIG. 3a shows the pinch rollers 34, 35 in their open position. In this position, it will be seen that the blanks 12 are free to pass between the pinch rollers 34, 35 without interference. It will be noted that this arrangement allows the possibility for the conveyor belt 21 to be used to feed blanks 12 to a plurality of opening stations in a production line.

FIG. 3b shows the pinch rollers 34, 35 in their closed position. In this position, the blank has been caught between the pinch rollers 34, 35 and fed via moving belts 32, 33 to the counter-rotating drums 30, 31. The blank has then been ejected from the nip between the drums 30, 31 in the direction of arrow B.

It will be noted that the blank is oriented with its free edges 13 leading, with respect to the direction of arrow B. This means that when the blank emerges from the nip between the drums 30, 31, there will be a tendency for it to open out as its free edges 13 catch the air, in a manner similar to the opening of a parachute. The frictional forces acting on the blank from the drums 30, 31 and belts 32, 33 will tend to assist with this opening out process, as will the selectively applied suction pressure. Further assistance may be provided, if necessary, for example by training a jet of air on the free edges 13 of the blank in a direction opposite to arrow B. From its emergence from the nip between the drums 30, 31, the now partially opened blank 36 is thrown onto a conically shaped former 37.

The partially opened blank 36 preferably goes fully onto the former 37, so that it will accurately take up the desired conical form of the finished wipe. This process may be assisted, for example by the use of vacuum suction pressure acting through holes 38 in the former 37. Other measures, such as electrostatic charge, might also be used in the process. The finished form of the wipe may be further perfected by tamping the blank in position on the former 37.

The former 37 may conveniently be one of a plurality of similar formers that are mounted on a movable carriage, eg in the form of a rotatable carousel. This allows the possibility for blanks to be fed to successive formers in turn as the carriage is indexed forward. Finished wipes can then be fed from the formers into tubes to form stacks.

1. A method of producing wipes in a three dimensional form from an essentially flat piece of material, including putting at least two creases in the piece of material, folding the piece of material about these creases to create a blank of essentially planar form, and opening out said blank into a three dimensional form.

2. A method as claimed in claim 1 wherein said opening out of the blank involves imparting an impetus to it.

3. A method as claimed in claim 2 wherein the impetus that is imparted to the blank is in the plane of its planar form.

4. A method as claimed in claim 2 wherein the blank is provided with free, ie unfolded edges and the impetus that is imparted to it is applied with the free edges leading.

5. A method as claimed in claim 2 wherein imparting an impetus to the blank includes use of a pair of counter-rotating drums between which the blank is fed.

6. A method as claimed in claim 5 and including ejecting the blank from between the drums onto a shaped former.

7. A method as claimed in claim 1 wherein said opening out of the blank involves the use of vacuum and/or air pressure.

8. A method as claimed in claim 1 and further including cutting the blank from a continuous web of material.

9. A method as claimed in claim 8 wherein the steps of cutting the blank and putting said creases into it are accomplished in the same operation.

10. A method as claimed in claim 1 wherein the blank is folded about the at least two creases in opposite directions to form pleats that lie on opposite sides of the blank.

11. A method as claimed in claim 1 and including selecting individual blanks from a line of moving blanks, where said selection takes place at right angles to the direction of movement of the line.

12. Apparatus for manufacturing a wipe in a three dimensional form out of an essentially flat piece of material, said apparatus including means for putting at least two creases in the piece of material, means for folding the piece of material about these creases to create a blank of essentially planar form, and means for opening out the blank into a three dimensional form.

13. Apparatus as claimed in claim 12 wherein said means for opening out the blank comprises means for imparting an impetus to it.

14. Apparatus as claimed in claim 13 wherein said means for imparting an impetus to the blank is arranged to do so in the plane of its planar form.

15. Apparatus as claimed in claim 13 wherein the blank is provided with free, ie unfolded edges and the means for imparting an impetus to the blank is arranged to be applied with the free edges leading.

16. Apparatus as claimed in claim 13 wherein said means for imparting an impetus to the blank comprises a pair of counter-rotating drums between which the blank is fed.

17. Apparatus as claimed in any claim 12 wherein the means for opening out the blank comprises means for selecting individual blanks from a moving line of blanks.

18. Apparatus as claimed in claim 17 wherein said blank selecting means operates at right angles to the direction of movement of the line of blanks.

19. Apparatus as claimed in claim 17 wherein said blank selecting means comprises a pair of openable and closable pinch rollers.

20. Apparatus as claimed in any claim 12 and further comprising a shaped former for setting the blank in three dimensional form.

21. Apparatus as claimed in claim 20 and further including means for tamping the blank against the former to set its three dimensional form.

22. Apparatus as claimed in claim 12 wherein said means for opening out said blank includes means for deploying vacuum and/or air pressure.

23. Apparatus as claimed in claim 22 wherein said means for deploying vacuum and/or air pressure assists with holding the blank on the former and/or ejecting the blank from it.
